(19) United States
(12) Patent Application Publication
(10) Pub. No.: US 2012/0295752 A1
(43) Pub. Date: Nov. 22, 2012

(54) STABILIZING STRUCTURE OF MODEL CAR

(76) Inventor: Teng-Hsiang Ho, Taichung City (TW)

(21) Appl. No.: 13/108,813

(22) Filed: May 16, 2011

(51) Int. Cl. F16H 48/06

(52) U.S. Cl. 475/220

(57) ABSTRACT

The present invention provides a stabilizing structure of a model car including two tires, a differential between the tire, and two transmission shafts having opposite ends connected to the tires and the differential respectively. The differential has a case, a pair of bearings disposed on the case, and a pair of shafts. The shafts pass through opposite walls of the case. Each of the shafts has an opening, and the opening extends through the corresponding bearing. The transmission shafts have ends connected to the tires and opposite ends movably connected to the openings of the shafts. The transmission shafts of the present invention are longer than the conventional transmission shafts. It may reduce the swinging angle when the model car runs on a rough road to stabilize the car and raise the speed.

### BACKGROUND OF THE INVENTION

1. Field of the Invention

The present invention relates generally to a model car, and more particularly to a stabilizing structure for a model car.

2. Description of the Related Art

FIG. 1 shows a conventional differential of a model car, including a case 1, a main gear 2 fixed to an end of the case 1. The case 1 and the main gear 2 each has a neck 1a, 2a projected outwards and a bearing 3 fitted to the neck 1a, 2a. The differential further has a planetary gear set 4 received in the case, and a pair of transmission shafts 5 passing through the case 1 and the main gear 2. An end of the transmission shaft 5 in the case 1 is connected to a sun gear 6 meshed with the planetary gear set 4. The other end of the transmission shaft 5 is stuck out of the case 1 and has an expansion portion 5a, and a bore 5b on a distal end of the expansion portion 5a. A ball joint 7a of an axle 7 is received in the bore 5b of the transmission shaft 5. As shown in FIG. 2, the differential is received in a base 8 with the expansion portions 5a of the transmission shafts 5 stuck out of the base 8. A distal end of the shaft 7 is connected to a tire 9.

The conventional differential may help the model car to turn. However, in a racing game of model cars, the stabilization of the car and the weight are the key points affecting the speed. Take the model car shown in FIG. 1 and FIG. 2 for example, the expansion portion 5a of the transmission shaft 5 is stuck out of the base 8, and the bore 5b extends in the expansion portion 5a only that the end where the ball joint 7a of the axle 7 is in front of the bearing 3. In other words, when the axle 7 moves up and down along with the wheel 9, the axle 7 will swing in a great angle. This will lift the center of weight of the model car, reduce the grip of the tire 9, and slow down the car.

Besides, the expansion portion 5a of the transmission shaft 5 is greater than the bearing 3 that it has to disassemble the entire differential before replace the bearing 3.

### SUMMARY OF THE INVENTION

The primary objective of the present invention is to provide a stabilizing structure of a model car, which may stabilize the model car in high speed.

According to the objective of the present invention, the present invention provides a stabilizing structure of a model car including two tires, a differential between the tire, and two transmission shafts having opposite ends connected to the tires and the differential respectively. The differential has a case having a first wall and a second wall on opposite sides thereof, a pair of bearings disposed on outer sides of the first wall and the second wall, and a pair of shafts, each of which has an opening, passing through the first wall and the second wall respectively, wherein the opening of the shaft extends through the corresponding bearings. The transmission shafts have ends connected to the tires and opposite ends movably connected to the openings of the shafts.

In an embodiment, each of the shafts has at least a slot on a sidewall of the opening, and opposite ends of the slot are closed. Each of the transmission shaft has a ball joint received in the opening and a post on the ball joint engaged with the slot.

In an embodiment, the differential has a differential unit received in a chamber of the case, and the differential unit has a plurality of driving gears. Each of the axle has a shaft, on which the opening is provided, and a driven gear at an end of the shaft, and wherein the opening has an inner end arriving the driven gear, and the driving gears are meshed with the driven gears respectively.

### BRIEF DESCRIPTION OF THE DRAWINGS

FIG. 1 is a sectional view of the conventional differential;

FIG. 2 is a sketch diagram of the conventional differential mounted on the model car;

FIG. 3 is a sketch diagram of the stabilizing structure of a preferred embodiment of the present invention incorporated in the model car;

FIG. 4 is an exploded view of the differential of the preferred embodiment of the present invention;

FIG. 5 is a perspective view of the differential of the preferred embodiment of the present invention;

FIG. 6 is a sectional view of the differential of the preferred embodiment of the present invention;

FIG. 7 is a sectional view of the shaft of the differential of the preferred embodiment of the present invention;

FIG. 8 is a perspective view of another shaft of the differential of the preferred embodiment of the present invention; and

FIG. 9 shows the shaft of FIG. 8 incorporated in the differential.

### DETAILED DESCRIPTION OF THE INVENTION

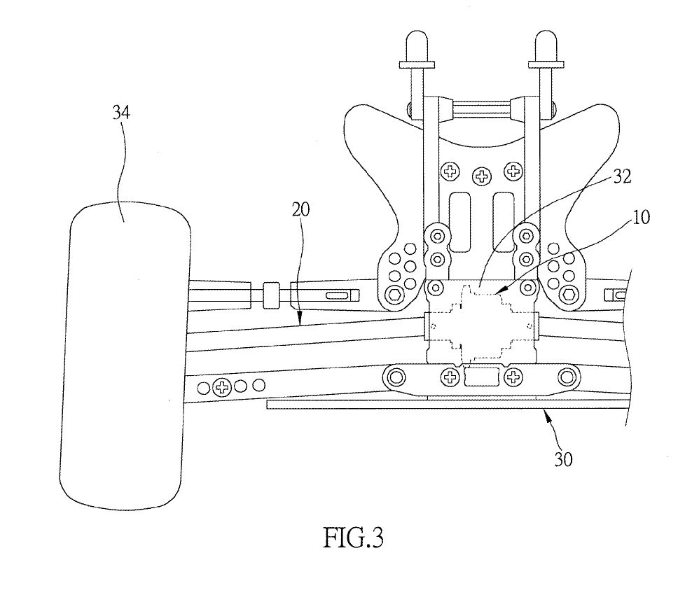

FIG. 3 shows a stabilizing structure of a model car of the preferred embodiment of the present invention, including a differential 10 and two transmission shafts 20. The differential 10 is mounted at a center of a car 30 and is embedded in a plastic base 32.

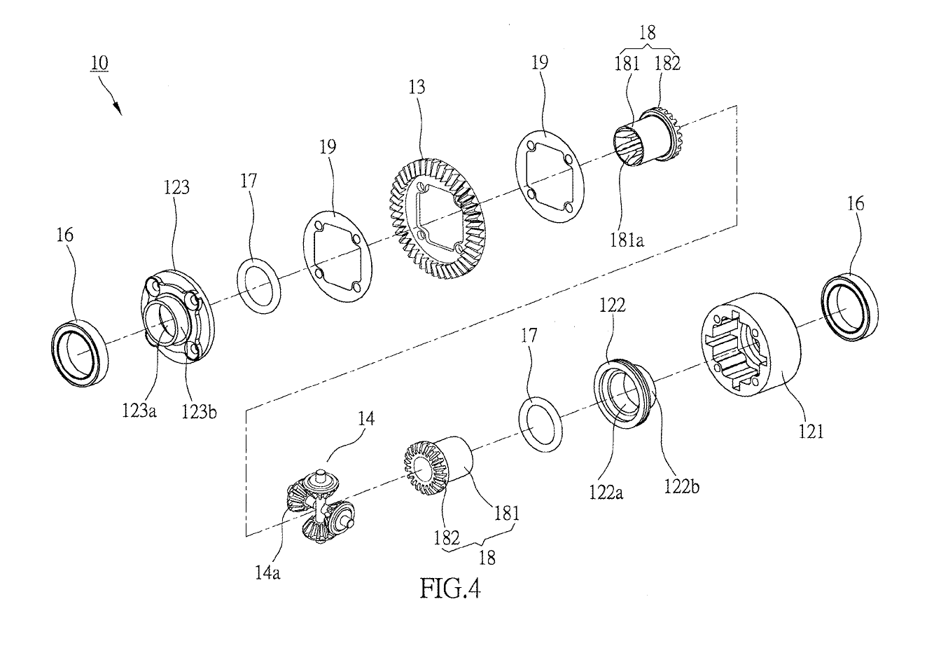

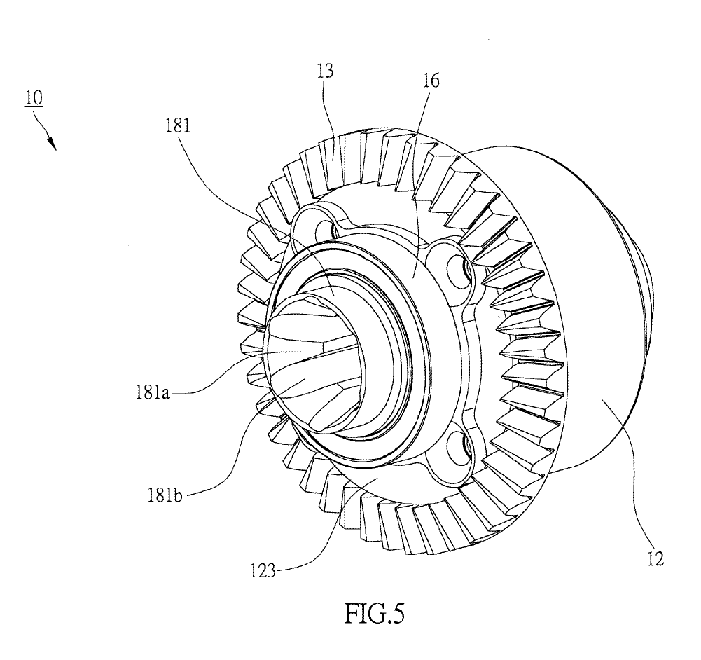

As shown in FIG. 4 to FIG. 6, the differential 10 includes a case 12, a main gear 13, a differential unit 14, a pair of bearings 16, and a pair of axles 18.

The case 12 has a hollow barrel 121 with opposite ends fixed to a first wall 122 and a second wall 123 to form a closed chamber 121a in the barrel 121. The second wall 123 is provided with the main gear 13 and two wearproof members 19 at opposite sides of the main gear 13. The differential unit 14 is received in the chamber 121a of the barrel 121. In the present invention, the differential unit 14 includes four driving gears 14a to be the planetary gear set. The first wall 122 and the second wall 123 are provided with a bore 122a, 123a and a ring 122b, 123b surrounding the bore 122a, 123a respectively. The bearings 16 are fitted to the ring 122b, 123b that the bearings 16 are mounted on outside of the case 12.

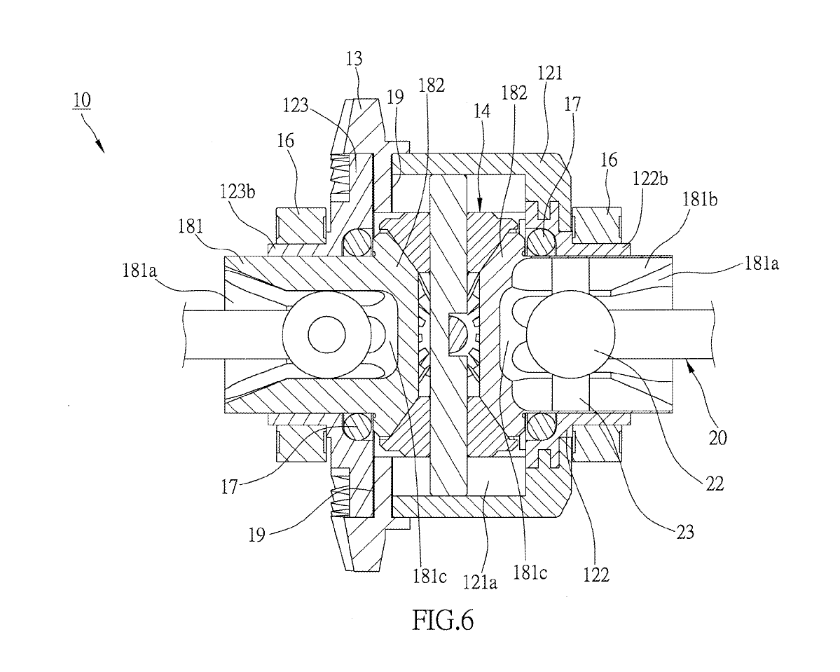

Each axle 18 has a shaft 181 and a driven gear 182 on an end of the shaft 181. In the present invention, the shaft 181 and the driven gear 182 are made in a single element. As shown in FIG. 6, the shafts 181 of the axles 18 pass through the bore 122a, 123a of the first wall 122 and the second wall 123 respectively with two sealing rings 17 between sidewalls of the bore 122a, 123a and the shafts 181. The driven gears 182 are received in the chambers 121 a and are meshed with the driving gears 14a.

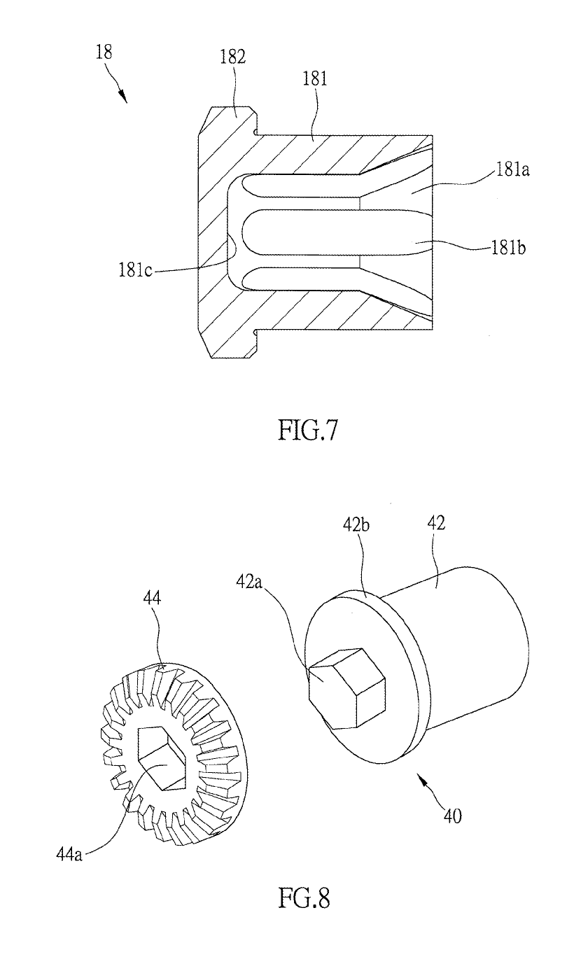

As shown in FIG. 7, each shaft 181 of the axle 18 is provided with an opening 181a and several slots 181b on a sidewall of the opening 181a. Opposite ends of the slots 181b are closed. The opening 181a has an inner end 181c. A diameter at a distal end of the opening 181a is greater than at the inner end 181c. The inner end 181c of the opening 181a arrives the driven gear 182 that the opening 181a will pass through the bearing 16.

Each transmission shaft 20 has a ball joint 22 and a post 23 on the ball joint 22. The ball joint 22 is received in the opening 181a of the shaft 181 with the post 23 engaged with the slots 181b that the ball joint 22 may reciprocate in opening 181a along the slots 181b and may rotate along with the axle 18. The other end of the transmission shaft 20 is connected to a tire 34.

The main characters of the stabilizing structure of the present invention are described in following:

The openings 181a of the axles 18 pass through the corresponding gearing 16, and the inner ends 181c thereof arrive the driven gears 182. This structure may have the flowing functions:

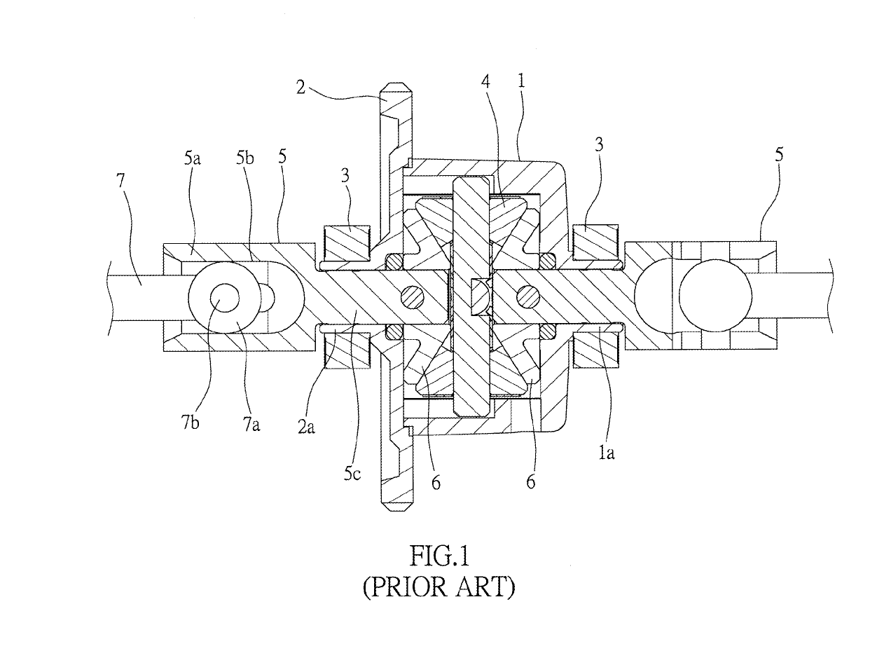

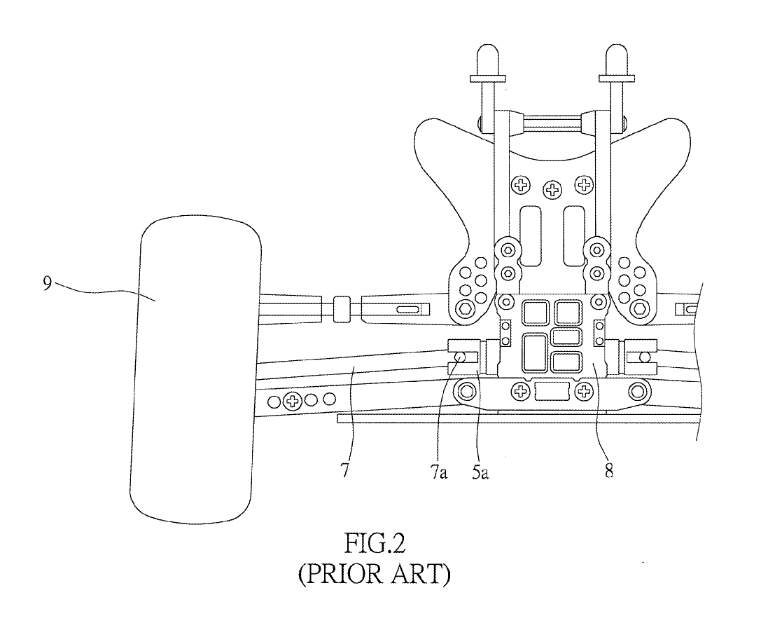

1. The transmission shafts 20 of the present invention are longer than the conventional transmission shaft 7 (FIG. 1) that the swinging angles of the transmission shafts 20 of the present invention are smaller than the conventional transmission shaft when the car runs on a rough road. This model car equipped with the stabilizing structure of the present invention is stable in high speed.

2. The axles 18 of the present invention are shorter than the conventional axle that the model car equipped with the stabilizing structure of the present invention is lighter, and this may raise the speed.

3. The axles 18 pass through the first and second lids 122, 123 respectively, and the bearings 16 are mounted on the rings 122b, 123b that the bearings 16 may be taken off from the case 12 directly without having to remove or disassemble any element first.

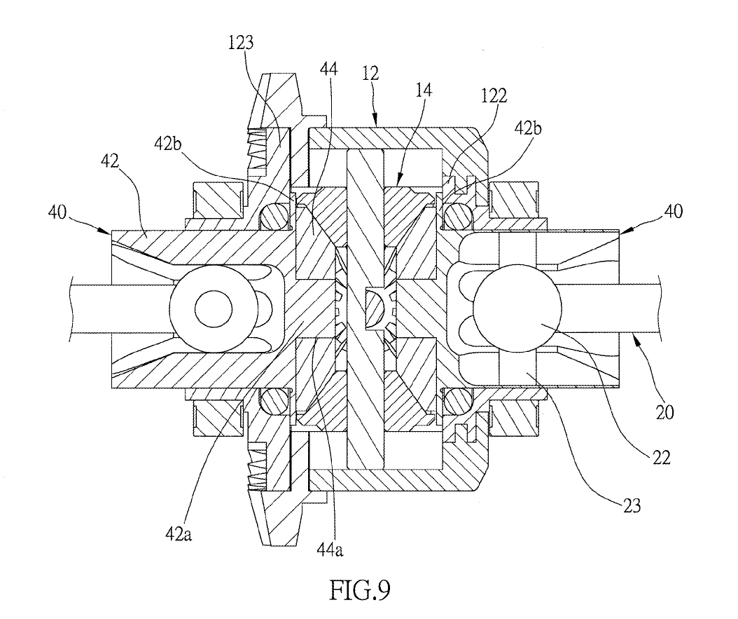

FIG. 8 and FIG. 9 show another axle 40 having a shaft 42 and a driven gear 44. The shaft 42 and the driven gear 44 are two independent elements connected together. The shaft 42 has a polygonal section 42a, and the driven gear 44 has a polygonal bore 44b that the polygonal section 42a of the shaft 42 may be inserted into the polygonal bore 44b of the driven gear 44 to drive the driven gear 44 to rotate. The shaft 42 further has a stop plate 42b, on which the polygonal section 42a is provided. The stop plates 42b of the shafts 42 are rested on inner sides of the first and second lids 122, 123 to stop the shafts 42 from falling out of the case 12.

The description above is a few preferred embodiments of the present invention and the equivalence of the present invention is still in the scope of claim construction of the present invention.

What is claimed is:

1. A stabilizing structure of a model car, comprising two tires, a differential between the tire, and two transmission shafts having opposite ends connected to the tires and the differential respectively;
the differential including a case having a first wall and a second wall on opposite sides thereof, a pair of bearings disposed on outer sides of the first wall and the second wall, and a pair of shafts, each of which has an opening, passing through the first wall and the second wall respectively, wherein the opening of the shaft extends through the corresponding bearings; and
the transmission shafts having ends connected to the tires and opposite ends movably connected to the openings of the shafts.

2. The stabilizing structure of the model car as defined in claim 1, wherein each of the shafts has at least a slot on a sidewall of the opening, and opposite ends of the slot are closed, and each of the transmission shaft has a ball joint received in the opening and a post on the ball joint engaged with the slot.

3. The stabilizing structure of the model car as defined in claim 1, wherein the differential has a differential unit received in a chamber of the case, and the differential unit has a plurality of driving gears, and each of the axle has a shaft, on which the opening is provided, and a driven gear at an end of the shaft, and wherein the opening has an inner end arriving the driven gear, and the driving gears are meshed with the driven gears respectively.

4. The stabilizing structure of the model car as defined in claim 3, wherein the shaft and the driven gear are made into a signal element.

5. The stabilizing structure of the model car as defined in claim 3, wherein the shaft of the axle has a polygonal section, and the driven gear has a polygonal bore that the polygonal section of the shaft is inserted into the polygonal bore of the driven gear.

6. The stabilizing structure of the model car as defined in claim 5, wherein the shafts of the axles further have a stop plate respectively, on which the polygonal section is provided, and the stop plates are rested on inner sides of the first wall and the second wall respectively.

7. The stabilizing structure of the model car as defined in claim 3, wherein the case further has a barrel, on opposite ends of which the first wall and the second wall are provided, and two sealing rings between the walls and the shafts respectively.

8. The stabilizing structure of the model car as defined in claim 7, wherein the first wall and the second wall have a ring respectively, on which the bearings are provided.

9. The stabilizing structure of the model car as defined in claim 7, wherein the case of the differential is provided with a main gear on the second wall.
